(19) United States
(12) Patent Application Publication
(10) Pub. No.: US 2025/0300807 A1
(43) Pub. Date: Sep. 25, 2025

(54) TECHNIQUES FOR OPTIMIZING BOOTSTRAPPING EXECUTION OF A FULLY HOMOMORPHIC ENCRYPTION

(71) Applicant: Chain Reaction, Ltd., Tel Aviv (IL)

(72) Inventors: Oren VRUBEL, Tel Aviv (IL); Ilan ROSENFELD, Petah Tikva (IL); Noam KLEINBURD, Hashmonaim (IL)

(73) Assignee: Chain Reaction, Ltd., Tel Aviv (IL)

(21) Appl. No.: 18/982,553

(22) Filed: Dec. 16, 2024

Related U.S. Application Data
(60) Provisional application No. 63/568,472, filed on Mar. 22, 2024.

(51) Int. Cl. H04L 9/00; G06F 21/57

(52) U.S. Cl. CPC H04L 9/008; G06F 21/575; G06F 2221/034

(57) ABSTRACT

A method and system of the device may include obtaining hardware constraints of an FHE accelerator configured to execute the FHE program. In addition, the device may include selecting an optimal bootstrapping configuration that corresponds to the hardware constraints. The device may include identifying repetitive data patterns in the auxiliary data to be used in the bootstrapping process. Moreover, the device may include reducing the auxiliary data by applying at least one auxiliary data optimization technique based on the repetitive data patterns. Also, the device may include modifying the FHE program to include an instruction to load at least a portion of the reduced auxiliary data into an internal memory of the FHE accelerator, where the at least a portion of the reduced auxiliary data is loaded to the internal memory once prior to the execution of the plurality of bootstrapping processes.

### CROSS-REFERENCE TO RELATED APPLICATIONS

This application claims the benefit of U.S. Provisional Application No. 63/568,472 filed on Mar. 22, 2024, the contents of which are hereby incorporated by reference.

### TECHNICAL FIELD

The present disclosure relates generally to fully homomorphic encryption (FHE) schemes and, more specifically, to a bootstrapping process of FHE schemes.

### BACKGROUND

Fully Homomorphic Encryption (FHE) enables computations on encrypted data without the need to decrypt it first. The Cheon-Kim-Kim-Song (CKKS) scheme is one such encryption method used in FHE, particularly well-suited for arithmetic operations on complex numbers. The core feature of FHE is its ability to perform computations on encrypted data. With CKKS, one can perform addition, subtraction, and multiplication on ciphertexts, which correspond to similar operations on the original plaintext numbers. To make the scheme more efficient, a sequence of values can be encrypted into a single ciphertext, and this sequence can be rotated. Importantly, CKKS allows for these operations to be performed with relatively low noise growth, which is a significant challenge in FHE. As operations are performed on ciphertexts, noise within the encrypted data accumulates. If the noise grows too large, it can make the decrypted result incorrect. CKKS manages this noise by scaling down ciphertexts after multiplications.

The CKKS scheme includes a technique for controlling this noise called rescaling, which also reduces the size of the ciphertext. When the size of a ciphertext reaches a certain threshold, the bootstrapping process can be applied. Bootstrapping refreshes the ciphertext, increasing its size and enabling more computations to be performed. This process is crucial, allowing FHE schemes to practically perform an unlimited number of homomorphic computations on encrypted data.

The related art describes several techniques for performing the bootstrapping process, typically involving three major steps. As illustrated in FIG. 1, process 100, the first step, 110, is the Coefficients-to-Slots (C2S) step, followed by a polynomial evaluation (Sine) 120, and finally, the Slots-to-Coefficients (S2C) step 130. In an FHE scheme, an encrypted message is represented as a polynomial. The C2S step 110 homomorphically evaluates the Inverse Discrete Fourier Transform (IDFT) and produces a ciphertext that can be further evaluated. The Sine step 120 implements the homomorphic modular reduction on the ciphertext. This reduction is approximated by a sinusoidal (Sine) function, which scales the message down and produces a remainder polynomial from the modular operation (typically modulo 1). The message is then scaled back up. The scheme parameters determine the range and degree of the approximation, with the Sine step 120 accounting for the secret-key density ‘h’. The S2C step 130 homomorphically evaluates the DFT on the ciphertext to revert it to approximately the original encrypted message.

The bootstrapping process is a crucial part of any application performing FHE operations. It is executed to ensure that the noise resulting from operations does not grow too large, which could lead to an incorrect decrypted result. The frequency of executing the bootstrapping process is determined by the application programmer and must be frequent enough to maintain the accuracy of the decrypted result.

The bootstrapping process is typically complex and requires a significant amount of computational and memory resources. To effectively apply FHE schemes in real-time commercial applications, there is a need to accelerate the bootstrapping operation.

Therefore, it would be advantageous to provide a solution that overcomes the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the method may include obtaining hardware constraints of an FHE accelerator configured to execute the FHE program. Method may also include selecting an optimal bootstrapping configuration that corresponds to the hardware constraints. Method may furthermore include identifying repetitive data patterns in the auxiliary data to be used in the bootstrapping process. Method may in addition include reducing the auxiliary data by applying at least one auxiliary data optimization technique based on the repetitive data patterns. Method may moreover include modifying the FHE program to include an instruction to load at least a portion of the reduced auxiliary data into an internal memory of the FHE accelerator, where at least a portion of the reduced auxiliary data is loaded to the internal memory once prior to the execution of the FHE program. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: obtain hardware constraints of an FHE accelerator configured to execute the FHE program; select an optimal bootstrapping configuration that corresponds to the hardware constraints; identify repetitive data patterns in the auxiliary data to be used in the bootstrapping process; reduce the auxiliary data by applying at least one auxiliary data optimization technique based on the repetitive data patterns; and modify the FHE program to include an instruction to load at least a portion of the reduced auxiliary data into an internal memory of the FHE accelerator, where the at least portion of the reduced auxiliary data is loaded to the internal memory once prior to the execution of the FHE program. Other embodiments of this aspect include corresponding computer systems, apparatus, and computer programs recorded on one or more computer storage devices, each configured to perform the actions of the methods.

In one general aspect, a system may include one or more processors configured to optimize a bootstrapping process of an FHE program. The system may also include obtaining hardware constraints of an FHE accelerator configured to execute the FHE program. The system may furthermore include selecting an optimal bootstrapping configuration that corresponds to the hardware constraints. The system may in addition include identifying repetitive data patterns in the auxiliary data to be used in the bootstrapping process. The system may moreover include reducing the auxiliary data by applying at least one auxiliary data optimization technique based on the repetitive data patterns. The system may also include modifying the FHE program to include an instruction to load at least a portion of the reduced auxiliary data into an internal memory of the FHE accelerator, where at least a portion of the reduced auxiliary data is loaded to the internal memory once prior to the execution of the FHE program including a plurality of bootstrapping processes. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings. In the drawings:

FIG. 1 illustrates the steps of a bootstrapping process in an FHE scheme.

FIG. 2 shows an exemplary block diagram of a server in accordance with some of the disclosed embodiments.

FIG. 3A shows a data load example during the FHE program.

FIG. 3B shows a data load during a run of the FHE program in accordance with some of the disclosed embodiments.

FIG. 4 shows an exemplary flowchart of a method for optimizing the execution of a bootstrapping process in accordance with some of the disclosed embodiments.

FIG. 5 shows a graph illustrating performance across different memory sizes for a given physical area of a semiconductor chip.

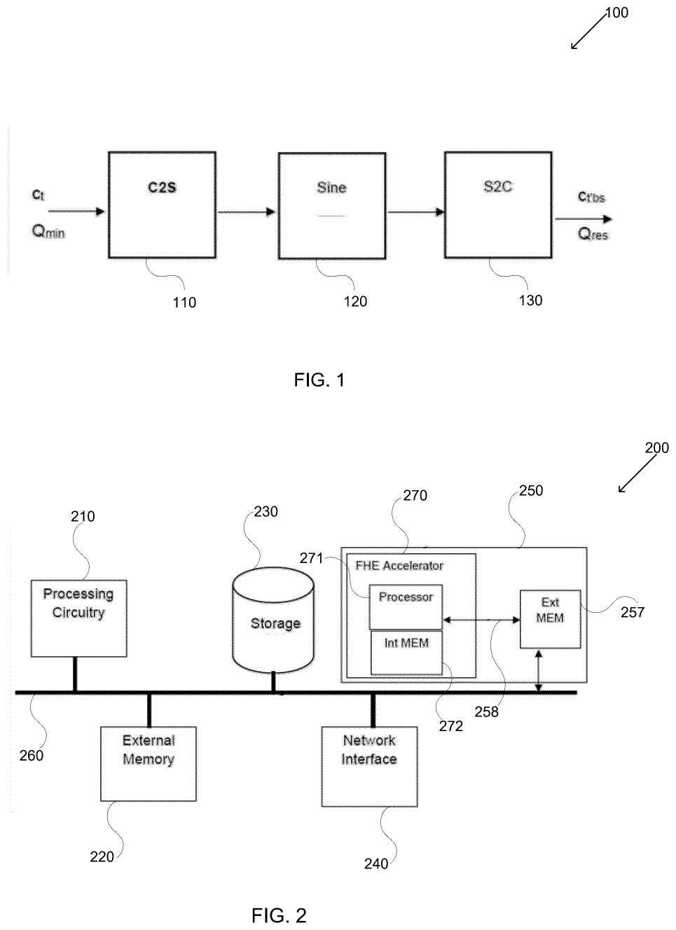

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The present disclosure aims to provide a computing system configured to facilitate the execution of FHE programs, with a particular focus on the bootstrapping process. Specifically, the computing system is designed to implement one or more methods for optimizing bootstrapping, reducing the memory footprint and execution overhead of an FHE accelerator.

In some exemplary embodiments, the methods include obtaining hardware constraints of an FHE accelerator designed to execute an FHE program and selecting an optimal bootstrapping configuration based on these constraints. The methods may also involve identifying repetitive data patterns in the auxiliary data used for the bootstrapping process, optimizing this data by applying various reduction techniques, and then loading a portion or all of the optimized data into the internal memory of the FHE accelerator. It should be noted that the reduced data may be loaded only once prior to the full execution of the FHE program. Alternatively, the reduced data may be loaded to internal memory only once per execution of the FHE program. In some exemplary embodiments, computing systems may be configured to perform methods that involve compressing matrix diagonals, reusing evaluation keys, and utilizing on-die memory for enhanced efficiency.

One technical problem addressed by the disclosed subject matter revolves around optimizing the execution of the FHE program. This involves optimizing the bootstrapping process by reducing the auxiliary data used for bootstrapping and loading such data only once into the internal memory of an FHE accelerator, all while maintaining an optimal memory-computation balance.

Some disclosed embodiments allow for a reduction in the external memory bandwidth required for the bootstrapping process by leveraging key characteristics of FHE schemes. These characteristics include a deterministic sequence of operations and highly repetitive procedures based on constant auxiliary data, which dominate the program's execution time. As noted, the bootstrapping process may occur thousands of times during the run of an application (e.g., a single AI inference) performing homomorphic operations.

The auxiliary data structures used in FHE are quite large. As a result, the bandwidth required to repeatedly load this data from external memory can become a significant bottleneck, leading to delays in execution. This makes FHE schemes impractical for commercial applications.

According to the disclosed embodiments, the auxiliary data needed for bootstrapping is reduced, and a portion or all of it is loaded into the internal memory (on-die memory) of an FHE accelerator only once. This data reduction is achieved by optimizing the memory-computation tradeoff according to internal (on-die) memory constraints. Reducing the size of the auxiliary data is accomplished through manipulation of FHE scheme parameters, adjustment of FHE procedures, and reuse of the auxiliary data within the bootstrapping procedure. Various techniques are disclosed to allow for this data reduction.

The technical solutions disclosed herein allow for a reduction in the memory size of an FHE accelerator and a corresponding decrease in the cost of these accelerators. Furthermore, by loading the auxiliary data only once during a run, the execution of an FHE program is accelerated, as less external memory access is required. Implementing the disclosed embodiments can enable the use of smaller memory sizes, thereby reducing the chip area of the accelerator. This reduction in memory size and chip area also leads to lower power consumption for the FHE accelerator.

The disclosed embodiments can be applied to various FHE schemes, including but not limited to CKKS, BGV/BFV, scheme switching, and similar schemes.

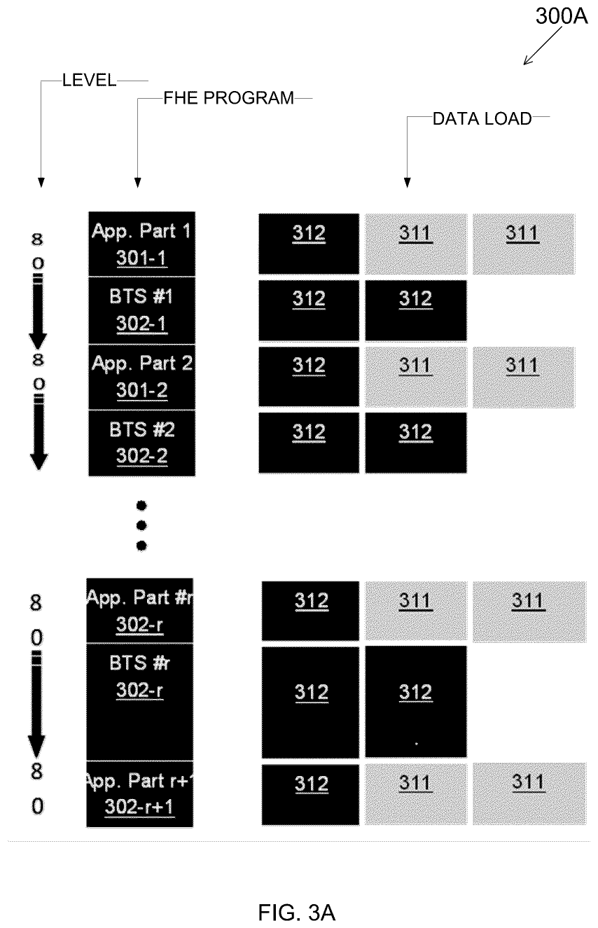

FIG. 2 is an example diagram of a server 200 utilized to explain the various disclosed embodiments. The server 200 includes a processing circuitry 210 coupled to a memory 220, a storage 230, a network interface 240, and an FHE card 250. In one embodiment, the components of server 200 may be communicatively connected via a bus 260.

The processing circuitry 210 may be realized as one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip (SoC) systems, graphics processing units (GPUs), tensor processing units (TPUs), general-purpose microprocessors, microcontrollers, digital signal processors (DSPs), and the like, or any other hardware logic components capable of performing calculations or other manipulations of information.

Memory 220 may be volatile (e.g., random access memory), non-volatile (e.g., read-only memory, flash memory), or a combination thereof. Storage 230 may include non-volatile memory devices, magnetic disk drives, optical disk drives, tape drives, and similar devices. Examples of memory 220 may include EEPROM, ROM, PROM, RAM, DRAM, SRAM, flash memory, firmware, programmable logic, and so on. Storage 230 may comprise internal storage, attached storage, and/or network-accessible storage. The network interface 240 allows server 200 to communicate with external systems, utilizing various communication protocols.

Memory 220 and/or storage 230 may store software required to execute an FHE program or application, that is, software that requires the execution of an FHE scheme to perform one or more homomorphic operations. The bus 260 may include, for example, a PCIe bus.

The FHE program involves repetitive execution of the bootstrapping process, which, according to the disclosed embodiment, is performed by the FHE accelerator 270. Software should be construed broadly to include any type of instructions, whether referred to as software, firmware, middleware, microcode, hardware description language, or otherwise. Instructions may include code in various formats, such as source code, binary code, executable code, or any other suitable format.

FHE card 250 is configured to rapidly perform complex homomorphic operations. The FHE card 250 can be installed in server 200 or operate as a standalone device. The FHE card includes an FHE accelerator 270.

The FHE accelerator 270 includes a processor 271 and an internal memory 272, or multiple processors with internal memory, designed to accelerate FHE scheme computational tasks. Processor 271 may include multiple cores capable of managing multiple computation threads simultaneously. Internal memory 272 is dedicated to storing data for executing the FHE program, such as auxiliary data, evaluation keys, indeterminate data, and the like. Internal memory 272 is designed for high bandwidth, enabling quick access to stored data. It is realized as on-die memory.

In one embodiment, the FHE accelerator 270 can be realized as an ASIC. In other embodiments, the FHE accelerator 270 can be realized as an FPGA, ASSP, SoC, or other hardware logic components capable of performing calculations or other manipulations of information.

The FHE card 250 also includes external memory 257 and a memory bus 258, which serves as the interface through which processor 271 communicates with external memory 257. Typically, external memory 257 is an SDRAM, high-bandwidth SDRAM (e.g., GDDR5, GDDR6), or high-bandwidth memory (HBM).

FHE card 250 also includes an interface to connect with bus 260. As noted, bus 260 and an interface may be PCIe.

According to the disclosed embodiments, the size of internal memory 272 is significantly smaller than that of external memory 257. Internal memory 272 is considered “on-die” memory, and the data stored there allows for the efficient execution of an FHE scheme, specifically the bootstrapping process of such a program. For example, the difference between the memory size of external memory and internal memory may be of an order of magnitude. In current technologies, the size of internal memory 272 is limited to 1 GB. Increasing the size of internal memory 272 would reduce the number of compute resources.

The bootstrapping process is usually complex and requires significant computational and memory resources. Specifically, a typical FHE bootstrapping process (or simply bootstrapping) would require 10 GB of memory in addition to the memory needed for executing other parts of the FHE program. Currently, in existing solutions, data and auxiliary data used for bootstrapping are saved and repetitively loaded from memory 220 or external memory 257 to internal memory 272 during the execution of bootstrapping. In a typical program, bootstrapping occurs hundreds to thousands of times.

The disclosed embodiments describe a method for efficient execution of the bootstrapping process. To achieve this, auxiliary data required for the process is loaded from memory 220 or external memory 257 to internal memory 272 only once. However, the size of internal memory 272 is limited, so the disclosed embodiments ensure the size of the auxiliary data is optimized while maintaining optimal performance for the entire FHE program.

The auxiliary data typically includes evaluation keys and data used for the computation of homomorphic I-DFT and DFT algorithms during the C2S and S2C steps of bootstrapping. Typically, such data includes diagonals of matrixes used for the computation. The reduction is achieved using one or more data reduction techniques discussed below. The various disclosed embodiments can reduce the size of the auxiliary data required for bootstrapping from 10 GB to less than 1 Gigabyte (GB).

It should be understood that the embodiments described herein are not limited to the specific architecture illustrated in FIG. 2, and other architectures may be used without departing from the scope of the disclosed embodiments.

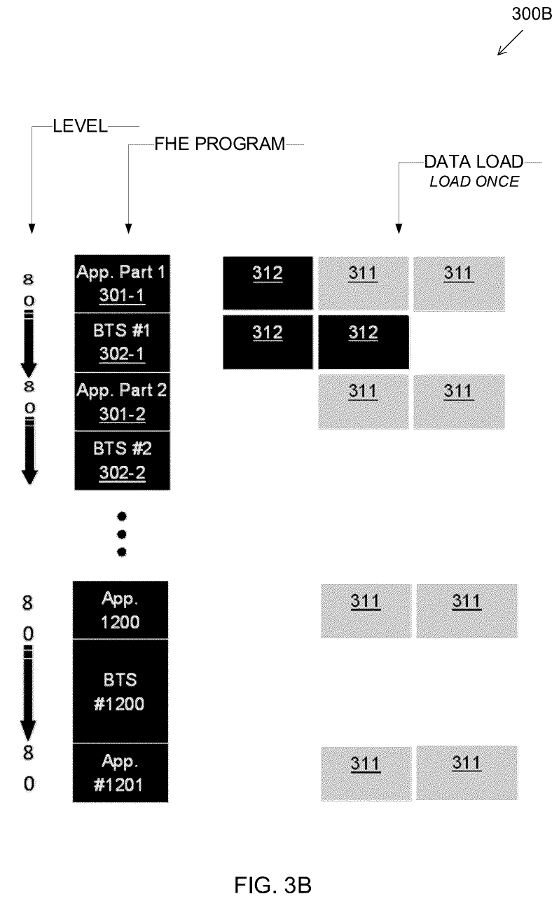

FIGS. 3A and 3B show an example of data loading during a run of the FHE program. An FHE program 300 is composed of application parts 301-1, . . . , 301-r+1 (where r is an integer equal to or greater than 1), which provide the computation for the task required by FHE program 300. The bootstrapping processes 302-1, . . . 302-r are also performed during a run of FHE program 300. A bootstrapping process is executed when the noise level increases and is typically scheduled as part of the coding of FHE program 300 by the programmer.

FIG. 3A shows an example 300A of data loading into the internal memory of an FHE accelerator as performed by prior art solutions. At each run of an application part 301-i (where i=1, . . . , r+1), compute data is loaded into the internal memory of an FHE accelerator. The compute data 311 is unique and required for the computation of the respective application part. For example, unique data may include a portion of an AI model. At each run of the bootstrapping process 302-1, repetitive data (collectively labeled as 312) is loaded into the internal memory of an FHE accelerator. Repetitive data 312 includes auxiliary data.

FIG. 3B shows an example 300B of data loading into the internal memory 272 of the FHE accelerator 270 according to the disclosed embodiments. At each run of an application part 301-1, compute data is loaded into the memory of an FHE accelerator. The compute data (collectively labeled as 311) is unique and required for the computation of the respective application part. For example, unique data 311 may include a portion of an AI model. According to the disclosed embodiments, for all runs of the bootstrapping process 302-1 or 302-2, repetitive data 312 is loaded only once into the internal memory of an FHE accelerator.

It should be noted that repetitive data 312 is smaller in size than what is typically used in the FHE program. The reduction in the size of repetitive data 312 is achieved using one or more auxiliary data optimization techniques. These techniques include but are not limited to, matrix diagonal compression, sparse-to-dense KSK compression, KSK size reduction, and key reuse.

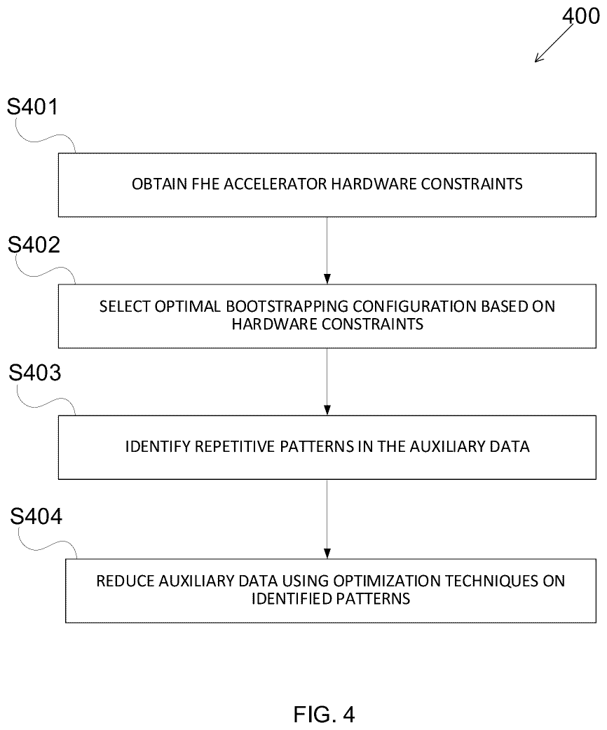

FIG. 4 is an example flowchart of method 400 for optimizing the execution of a bootstrapping process according to the disclosed embodiments. In some embodiments, a server, such as a server 200, may perform one or more process blocks of FIG. 4. The process will be described with reference to some elements shown in FIG. 2. In some exemplary embodiments, the method may be performed during a compilation phase of the FHE program by server 200 before the FHE accelerator 270 executes the bootstrapping process.

In some exemplary embodiments, method 400 is utilized by server 200 to optimize the bootstrapping process of an FHE program configured for execution by FHE accelerator 270.

Method 400 addresses key challenges in applying FHE schemes to real-time commercial applications by optimizing the bootstrapping process, thereby making FHE more practical and scalable for widespread use.

At S401, hardware constraints of the FHE accelerator 270 (of FIG. 2) may be obtained. In some exemplary embodiments, these hardware constraints include available compute resources and the size of the internal memory 272, e.g., 250 MB or less. These constraints directly influence the efficiency of the bootstrapping process, a resource-intensive operation that is crucial for maintaining the accuracy and feasibility of FHE computations. It should be noted that the bootstrapping process refreshes ciphertexts to deal with noise accumulation, enabling the FHE program to perform a virtually unlimited number of homomorphic operations.

At S402, an optimal bootstrapping configuration based on hardware constraints may be selected. In some exemplary embodiments, the selected optimal bootstrapping configuration corresponds to the hardware constraints and is tailored to maximize the performance of the FHE accelerator by ensuring an optimal tradeoff between memory usage and computational efficiency. The bootstrapping configuration is determined through a process that evaluates different parameter combinations, including FHE scheme parameters, bootstrapping parameters, and auxiliary data optimization techniques. These evaluations ensure that the chosen configuration allows for efficient execution while maintaining the required level of encryption and minimizing resource consumption.

The bootstrap (BTS) configuration defines a set of parameters that ensure an optimal memory-computation tradeoff point, given the hardware constraints, for peak utilization of auxiliary and intermediate data. In some exemplary embodiments, the set of parameters is determined using an evaluation process where different combinations of parameters are brute-force evaluated within relevant parametric domains and for different memory-computation ratios to determine which combination yields the best performance. Since such a combination of parameters is considered a BTS configuration, multiple BTS configurations can be determined based on different combinations of parameters.

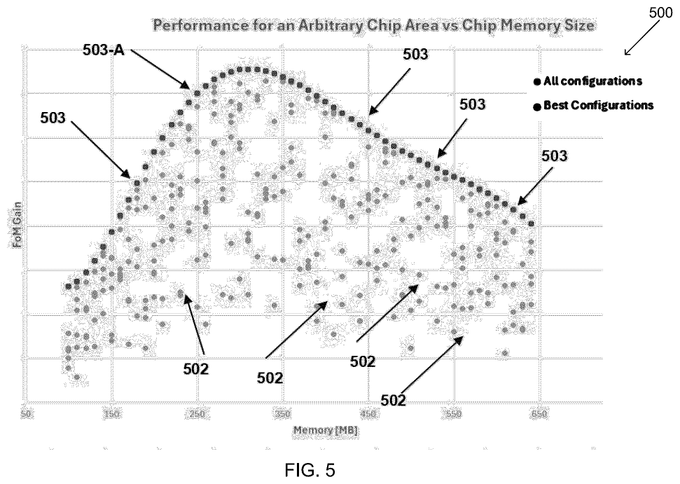

In one embodiment, the performance may be measured by a proprietary figure of merit (FoM) gain, as depicted in FIG. 5, which shows a graph 500 demonstrating performance (measured as FoM gain) for an arbitrary chip area with different memory sizes. The evaluated BTS configurations, labeled as ‘502’ (in FIG. 5), are computed for memory-computation tradeoff points. Therefore, the best BTS configurations for these tradeoff points are those that achieve the highest FoM gain, labeled ‘503’.

The parameters evaluated to determine BTS configurations include, for example, FHE scheme parameters, bootstrapping parameters, and hardware parameters. In one embodiment, the evaluated parameters also include auxiliary data reduction and reuse techniques (collectively referred to as “auxiliary data optimization techniques”). As discussed in detail below, the auxiliary data optimization techniques include matrix diagonal compression, sparse-to-dense key-switching key (KSK) compression, accelerated KSK size reduction, inter-step KSK reuse, and intra-step KSK reuse. Thus, a BTS configuration may designate one or more auxiliary data optimization techniques that achieve the best performance for a given memory size, compute resources, and set of FHE and BTS parameters.

The following are some examples of the evaluated parameters. The FHE scheme parameters may include the length of a plaintext polynomial (Degree) N, polynomial modulus Q, Special modulus P, and similar parameters. Bootstrapping parameters may include the polynomial modulus input to the process Qstart, and the residual polynomial modulus Qresd, matrix decomposition options, key-switching keys, and the like. The hardware parameters include chip area, memory size, compute resources, and other hardware constraints.

It should be noted that the evaluation of parameters to determine BTS configurations is not part of the disclosed method and may be performed before the execution of the method, and thus before the bootstrapping process. To this end, in one embodiment, S402 includes obtaining the best BTS configuration from a library using the input hardware constraints.

For example, given an FHE accelerator (chip) with an arbitrary memory size of 250 Megabytes (MB) and compute resources in the remaining chip area, the BTS configuration labeled 503-A in FIG. 5 may be obtained and used to reduce the auxiliary data's size, thereby optimizing the execution of the BTS process according to the disclosed embodiments.

At S403, repetitive patterns in the auxiliary data that are used during the bootstrapping process are identified. These patterns often consist of large, repetitive structures, such as matrix diagonals and key-switching keys (KSKs), which are commonly encountered in FHE program operations. Identifying these patterns is crucial for optimizing the size of auxiliary and intermediate data, as it prepares the data for subsequent reduction techniques and a more efficient bootstrapping process.

In some embodiments, these repetitive patterns may be predetermined, including elements like periodic diagonals of decomposed matrices and one or more KSKs. S403 may also involve scanning the original auxiliary data to match these predetermined patterns. The identified repetitive data patterns may vary depending on the FHE scheme, its parameters, and the BTS parameters. Additionally, repetitive data patterns may be identified for different combinations of these parameters.

It should be noted that the bootstrapping process involves three primary steps: Coefficients-to-Slots (C2S), Sine evaluation, and Slots-to-Coefficients (S2C). This process is initiated whenever the current multiplicative level I of the ciphertext becomes too low to continue operations without decryption. The goal of bootstrapping is to increase or restore the multiplicative level L of the ciphertext, which, in one example, is set to 8.

It should also be noted that during the C2S step, an inverse Discrete Fourier Transform (DFT) is performed on the ciphertext ct. This DFT process can be described as a multiplication between a plaintext matrix D and an input vector v. The plaintext matrix D is decomposed into block-diagonal sparse matrixes M₁, . . . , M_{ρ}, where 1≤ρ≤log₂N/2. Each diagonal-sparse matrix M includes several non-zero diagonals, with all other elements set to zero. The number of diagonals can vary between matrices, and N represents the length of a plaintext polynomial.

Homomorphic multiplication is performed between each matrix M and an input vector v. This is performed by encoding the diagonals of the matrix as plaintexts and using the ciphertext as the vector. The multiplication process utilizes the Baby-Step Giant-Step (BSGS) algorithm, which rotates the input ciphertext and multiplies each rotation by the corresponding diagonals. The final result is the sum of all these products, with some requirements for additional rotations. The S2C step performs similar operations using a DFT process.

The key-switching process typically involves creating a special key related to the original encryption key. This special key is used to revert the ciphertext to the original encryption key after operations, such as ciphertext multiplication, which alters the encryption key under which the result is obtained. The key-switching process includes mathematical operations that ensure the underlying plaintext remains unchanged and that the transformation does not introduce significant additional noise. The specific mathematical operations involved in key-switching depend on the FHE scheme being used.

At S404, auxiliary data may be reduced using at least one optimization technique of identified repetitive data patterns. The selected technique(s) to be used are designated in the selected bootstrapping configuration. It should be emphasized that the size of the auxiliary data, or portion thereof is smaller than the size of the internal memory (memory constraints). This allows the loading of the reduced-size auxiliary data to the internal memory before the execution of the FHE program. In some exemplary embodiments, the optimization techniques may include compressing matrix diagonals, reusing encryption keys, and other methods that reduce the overall data, i.e., auxiliary data, size without compromising the functionality of the bootstrapping process. It should be noted that these reductions are required to improve the memory footprint and reduce execution overhead on the FHE accelerator.

In one embodiment, a matrix diagonal compression technique may be utilized. The compression of matrix diagonals can be performed before encoding, after encoding in coefficient mode, or after encoding in evaluation mode. This technique reduces the number of diagonals and their memory footprint, which in turn decreases the memory footprint. For example, a diagonal matrix originally sized at 3 GB can be compressed down to tens of megabytes, significantly lowering memory usage.

In another embodiment, a sparse-to-dense KSK compression technique may be utilized. This technique involves switching from a dense to a sparse secret key before bootstrapping and then reverting to a dense secret key during bootstrapping. This method can reduce the KSK data size by at least 100 MB, optimizing the auxiliary data for more efficient storage and processing.

In yet another embodiment, a KSK size-decreasing technique may be utilized by dynamically changing the modulus of the KSK, which can be reduced early in the process, saving tens of megabytes per KSK.

In yet another embodiment, KSK reuse techniques, such as KSK inter-stage reuse and intra-stage KSK reuse, may be utilized. The KSK reuse technique is based on using the same KSKs across various stages of the bootstrapping process. For example, KSKs used in the S2C step can be derived from those used in the C2S step, reducing the need for additional KSKs and saving up to tens of megabytes of memory. The intra-step KSK reuse may include a partial hoisting. By applying this technique, approximately 80 Megabytes (MB) can be reduced from the auxiliary data.

It should be noted that one or more, or any combination of the techniques mentioned above, can be applied to the repetitive data patterns to reduce the size of the auxiliary data. It should be further noted that the other techniques not mentioned herein can be applied to the repetitive data patterns to reduce the size of the auxiliary data.

In certain embodiments, S404 may include modifying the FHE program to include an instruction(s) that cause the one-time load of the reduced auxiliary data, or a portion of it, into the internal memory of an FHE accelerator.

In some embodiments, during an initialization phase of a bootstrapping process compiled according to the embodiments disclosed herein, the reduced auxiliary data, or a portion of it, may be loaded once into the FHE accelerator's internal memory. In some exemplary embodiments, loading the data only once minimizes the need for repeated transfers from external memory, which can significantly slow down the FHE program due to bandwidth limitations. This approach accelerates the execution of the bootstrapping process and allows the FHE accelerator to operate more efficiently, thereby reducing both memory usage and power consumption. In some embodiments, the FHE program may be modified to include instructions that trigger this one-time load of the reduced data into the internal memory, further enhancing the overall efficiency of the FHE accelerator.

Although FIG. 4 shows example blocks of process 400, in some implementations, process 400 may include additional blocks, fewer blocks, different blocks, or differently arranged blocks than those depicted in FIG. 4. Additionally, two or more of the blocks of process 400 may be performed in parallel.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for optimizing a bootstrapping process of a fully homomorphic encryption (FHE) program, comprising:
obtaining hardware constraints of an FHE accelerator configured to execute the FHE program;
selecting an optimal bootstrapping configuration that corresponds to the hardware constraints;
identifying repetitive data patterns in the auxiliary data to be used in the bootstrapping process;
reducing the auxiliary data by applying at least one auxiliary data optimization technique based on the repetitive data patterns; and
modifying the FHE program to include an instruction to load at least a portion of the reduced auxiliary data into an internal memory of the FHE accelerator, wherein the at least a portion of the reduced auxiliary data is loaded to the internal memory once prior to the execution of the FHE program including a plurality of bootstrapping processes.

2. The method of claim 1, wherein the hardware constraints include any one of: the available compute resources of the FHE accelerator and a size of the internal memory.

3. The method of claim 2, wherein the internal memory is on-die memory incorporated in the FHE accelerator.

4. The method of claim 1, wherein the optimal bootstrapping configuration is selected to maximize the FHE accelerator performance ensures an optimal tradeoff between memory usage and computational efficiency.

5. The method of claim 3, wherein selecting the optimal bootstrapping configuration further comprises:
evaluating multiple parameter combinations;
evaluating FHE scheme parameters;
determining bootstrapping parameters; and
utilizing auxiliary data optimization techniques.

6. The method of claim 5, wherein the parameter combinations are brute-force evaluated within parametric domains for different memory-computation ratios used to determine an optimal parameter combination to maximize FHE accelerator performance.

7. The method of claim 5, wherein the FHE accelerator performance may be measured by a proprietary figure of merit (FoM) gain.

8. The method of claim 4, wherein at least one auxiliary data optimization technique is any one of: an auxiliary data reduction technique; a matrix diagonal compression technique; a sparse-to-dense key-switching key (KSK) compression technique; an accelerated KSK size reduction technique; an inter-step KSK reuse technique; and intra-step KSK reuse.

9. The method of claim 1, wherein repetitive data patterns include at least one of: the periodic diagonals of decomposed matrixes, and at least one key-switch key (KSK).

10. The method of claim 9, wherein reducing the auxiliary data further comprises:
compressing matrix diagonals and reusing evaluation keys, thereby decreasing the memory footprint.

11. The method of claim 9, wherein reducing the auxiliary data further comprises:
applying a sparse-to-dense KSK compression configured to switch from a dense to a sparse secret key in an initialization phase of the bootstrapping process; and
reverting to a dense secret key during the execution of the bootstrapping process at the FHE accelerator.

12. The method of claim 9, wherein reducing the auxiliary data further comprises:
dynamically changing modulus of the KSK.

13. The method of claim 9, wherein reducing the auxiliary data further comprises:
using the same KSKs across various stages of the bootstrapping process.

14. The method of claim 1, wherein the method is performed by a processor external to the FHE accelerator during the compilation of the FHE program.

15. A non-transitory computer-readable medium storing a set of instructions for optimizing a bootstrapping process of a fully homomorphic encryption (FHE) program, the set of instructions comprising:
one or more instructions that, when executed by one or more processors of a device, cause the device to:
obtain hardware constraints of an FHE accelerator configured to execute the FHE program;
select an optimal bootstrapping configuration that corresponds to the hardware constraints;
identify repetitive data patterns in the auxiliary data to be used in the bootstrapping process;
reduce the auxiliary data by applying at least one auxiliary data optimization technique based on the repetitive data patterns; and
modify the FHE program to include an instruction to load at least a portion of the reduced auxiliary data into an internal memory of the FHE accelerator, wherein the at least a portion of the reduced auxiliary data is loaded to the internal memory once prior to the execution of the FHE program including a plurality of bootstrapping processes.

16. A system for optimizing a bootstrapping process of a fully homomorphic encryption (FHE) program comprising:
one or more processors configured to:
obtain hardware constraints of an FHE accelerator configured to execute the FHE program;
select an optimal bootstrapping configuration that corresponds to the hardware constraints;
identify repetitive data patterns in the auxiliary data to be used in the bootstrapping process;
reduce the auxiliary data by applying at least one auxiliary data optimization technique based on the repetitive data patterns; and
modify the FHE program to include an instruction to load at least a portion of the reduced auxiliary data into an internal memory of the FHE accelerator, wherein the at least a portion of the reduced auxiliary data is loaded to the internal memory once prior to the execution of the FHE program including a plurality of bootstrapping processes.

17. The system of claim 16, wherein the hardware constraints include any one of:
available compute resources of the FHE accelerator and a size of the internal memory.

18. The system of claim 17, wherein the internal memory is on-die memory incorporated in the FHE accelerator.

19. The system of claim 18, wherein the one or more processors, when selecting the optimal bootstrapping configuration, are configured to:
evaluate multiple parameter combinations;
evaluate FHE scheme parameters;
determine bootstrapping parameters; and
utilize auxiliary data optimization techniques.

20. The system of claim 19, wherein the parameter combinations are brute-force evaluated within parametric domains for different memory-computation ratios used to determine an optimal parameter combination to maximize FHE accelerator performance.

21. The system of claim 19, wherein the FHE accelerator performance may be measured by a proprietary figure of merit (FoM) gain.

22. The system of claim 16, wherein the optimal bootstrapping configuration is selected to maximize the FHE accelerator performance that ensures an optimal tradeoff between memory usage and computational efficiency.

23. The system of claim 22, wherein at least one auxiliary data optimization technique is any one of:
an auxiliary data reduction technique;
a matrix diagonal compression technique;
a sparse-to-dense key-switching key (KSK) compression technique;
an accelerated KSK size reduction technique;
an inter-step KSK reuse technique; and
intra-step KSK reuse.

24. The system of claim 16, wherein repetitive data patterns include at least one of:
periodic diagonals of decomposed matrixes; and
at least one key-switch key (KSK); and
any combination thereof.

25. The system of claim 16, wherein the method is performed by a processor external to the FHE accelerator during the compilation of the FHE program.
